(19) United States
(12) Patent Application Publication
(10) Pub. No.: US 2015/0193565 A1
(43) Pub. Date: Jul. 9, 2015

(54) METHOD OF SIMULATING OUTPUT OF NONLINEAR DYNAMICAL SYSTEM IN AN EVENT DRIVEN WAY

(71) Applicant: SEOUL NATIONAL UNIVERSITY R&DB FOUNDATION, Seoul (KR)

(72) Inventors: Jaeha KIM, Seoul (KR); Jieun JANG, Seoul (KR)

(73) Assignee: SEOUL NATIONAL UNIVERSITY R&DB FOUNDATION, Seoul (KR)

(21) Appl. No.: 14/148,258

(22) Filed: Jan. 6, 2014

(51) Int. Cl. G06F 17/50; G06F 17/13

(52) U.S. Cl. CPC G06F 17/5009; G06F 17/13

(57) ABSTRACT

A method of simulating an output of a nonlinear system modeling the output of the nonlinear system with a set of differential equations, the set of differential equations being expressed with a combination of first order to n-th order output responses, and an input signal with coefficients thereof, updating the coefficients of the first order to n-th order output responses when the coefficients of the input signal change to obtain the first order to n-th order output responses, and obtaining the output of the nonlinear system by summing the firstfirst order to n-th order output responses.

### TECHNICAL FIELD

This application relates to a method of simulating the response of a nonlinear dynamical system in an event-driven way.

### BACKGROUND

System simulation uses mathematical models to replicate the behavior of an actual system. Simulating a system's behavior before actually building it can greatly improve design efficiency by making faulty designs known, and providing insight into the behavior of system designs. The system to be simulated may be an electronic circuit, a mechanical system, a biological system, etc. For example, in the case of integrated circuits (ICs), it is too expensive and time consuming to implement the ICs and obtain the behaviors from the implemented ICs. Therefore, the IC design relies heavily on the simulation.

Simulators such as simulation program with integrated circuit emphasis (SPICE) are used to simulate the behaviors of the IC, for example complex analog/mixed-signal (AMS) systems. The existing simulator expresses a continuous-time waveform as a collection of piecewise linear (PWL) segments and employs an ordinary differential equation (ODE) solver to compute the response of a continuous-time dynamical system. The simulator, however, does not well replicate the behaviors of the AMS systems, since the simulator necessarily requires solving of ODEs, and simulating of the AMS systems demand the solving of large-dimension ODEs. This consumes significant time and hinders accurate simulation with elapse of time. Much less, these drawbacks become severe when weakly nonlinear systems such as spectral regrowth in RF transmitters are simulated.

Thus, a need exists for providing a simulator to replicate accurately and quickly behaviors of a nonlinear dynamic system.

### SUMMARY

An aspect of the present disclosure encompasses a method of simulating an output of a nonlinear dynamical system, modeling an electronic circuit, a mechanical device, biological system, economic market, etc. The method models the output of the nonlinear system with a set of differential equations, and the set of differential equations are expressed with a combination of first order to n-th order output responses and an input signal with coefficients thereof. The method updates the coefficients of the first order to n-th order output responses when the coefficients of the input signal change to thereby obtain first order to n-th order output responses, and obtains the output of the nonlinear system by summing the first order to n-th order output responses.

The modeling of the output of the nonlinear system includes modeling the output of the nonlinear system with a Volterra series, and reformulating the modeled output to the set of differential equations.

Each of the set of differential equations governing the k-th order output response yₖ(t) has one side expressed with k-th order output response yₖ(t) and time derivative of the k-th order output response yₖ(t), and the other side expressed with a polynomial function of the input signal x(t) and the lower-than-k order output responses y₁(t), . . . , yₖ₋₁(t).

The reformulating is performed by decomposing the modeled output into a set of differential equations with a perturbation method.

The step of updating the coefficients includes setting the first order to n-th order output responses at the time the new input signal is inputted as initial conditions of the first order to n-th order output responses, transforming each of the set of differential equations into s-domain equations with the set of initial conditions, obtaining the coefficients of each of the converted s-domain equations, and transforming the s-domain equations to the time domain to thereby obtain the first order to n-th order output responses.

The input signal, and the first to n-th order output responses are expressed as a combination of one or more exponential basis functions ct^{m}e^{a t}. A set of coefficients, including the c, m, and a for each basis function term describes the signal's waveform as a function of time t. The obtained output of the nonlinear system is effective from the time of a change of the coefficients of the input signal to the time of next change of the coefficients of the input signal.

Another aspect of the present disclosure relates to a non-transitory computer readable medium including instructions stored therein. Execution of the instructions by a processor causes the processor to model the output of the nonlinear system with a set of differential equations. The set of differential equations being expressed with a combination of first order to n-th order output response and an input signal with coefficients thereof. The processor updates the coefficients of the first order to n-th order output responses when the coefficients of the input signal change to obtain first order to n-th order output responses, and obtains the output of the nonlinear system by summing the first order to n-th order output responses.

The modeling of the output of the nonlinear system includes modeling the output of the nonlinear system with a Volterra series, and reformulating the modeled output to the set of differential equations.

Each of the set of differential equations governing the k-th order output response yₖ(t) has one side expressed with k-th order output response yₖ(t) and time derivative of the k-th order output response yₖ(t), and the other side expressed with a polynomial function of the input signal x(t) and the lower-than-k output responses y₁(t), . . . , yₖ₋₁(t).

The reformulating is performed by decomposing the modeled output into a set of differential equations with a perturbation method.

The updating of coefficients includes setting the first order to n-th order output responses at the time the new input signal is inputted as initial conditions of the first order to n-th order output responses, transforming each of the set of differential equations into s-domain equations with the set of initial conditions, obtaining coefficients of each of the converted s-domain equations, and transforming the s-domain equations to the time domain to thereby obtain the first order to n-th order output responses.

The input signal, and the first to n-th order output responses are expressed as a combination of one or more exponential basis functions ct^{m}e^{a t}. A set of coefficients, including the c, m, and a for each basis function term describes the signal's waveform as a function of time t. The obtained output of the nonlinear system is effective from the time of a change of the coefficients of the input signal to the time of the next change of the coefficients of the input signal.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 conceptually illustrates simulation of a nonlinear system.

FIG. 2 illustrates the conception of the present simulation.

FIG. 3 is a flow chart illustrating a method for simulating a behavior of a weakly nonlinear dynamical system in an event-driven way according to an embodiment.

FIG. 4 illustrates the initial condition conception of the present simulation.

FIG. 5 illustrates the accuracy and speed of the SPICE simulation and the present simulation.

FIG. 6 illustrates an R-C circuit of which outputs show weakly nonlinear behaviors.

FIG. 7 is a simplified functional block diagram of a personal computer or other work station or terminal device which implements a method of simulating an output of a nonlinear dynamical system.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The present disclosure encompasses the simulation of the response of a weakly nonlinear dynamical system or circuit in an event-driven way. Response of the nonlinear dynamical system is modeled with a Volterra series. The Volterra series model is decomposed to a set of differential equations each corresponding to a different-order component of the nonlinear system response. Each of the set of linear differential equations governing the k-th order output response yₖ(t) is expressed with an equation of which one side consists of the k-th order output response and its derivative, and of which the other side consists of a polynomial function of an input signal, and output responses with orders lower than k. The coefficients of the different-order responses are updated only when a new input event arrives. The resultant linear combination of the different-order responses accurately replicates the behavior of the weakly nonlinear dynamical system or circuit.

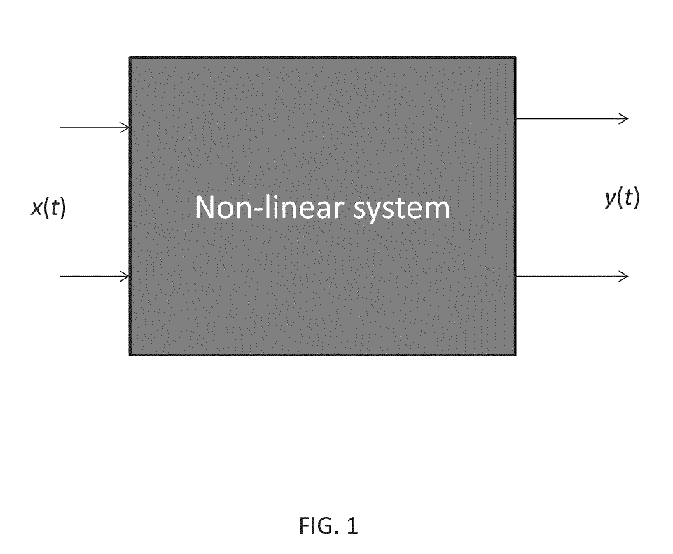

FIG. 1 conceptually illustrates the simulation of a nonlinear dynamical system, for example an integrated circuit (IC). The subject matter purports to simulate the response y(t) of the IC when the input signal x(t) is inputted. The IC is a weakly nonlinear system, such as a nonlinear power amplifier and a wireline data receiver having a nonlinear equalizer. The input signal x(t) and the output signal y(t) may be a current or a voltage or any signal. The output response of the weakly nonlinear circuit deviates from the output response of a linear circuit slightly. For simple and exact simulation, the input signal x(t), the output signal y(t) and k-th-distortion order response signal yₖ(t) of y(t) all are expressed in an analytical form, for example, a linear combination of exponential basis functions ct^{m}e^{a t}, where parameters c, m and a can be complex numbers in general.

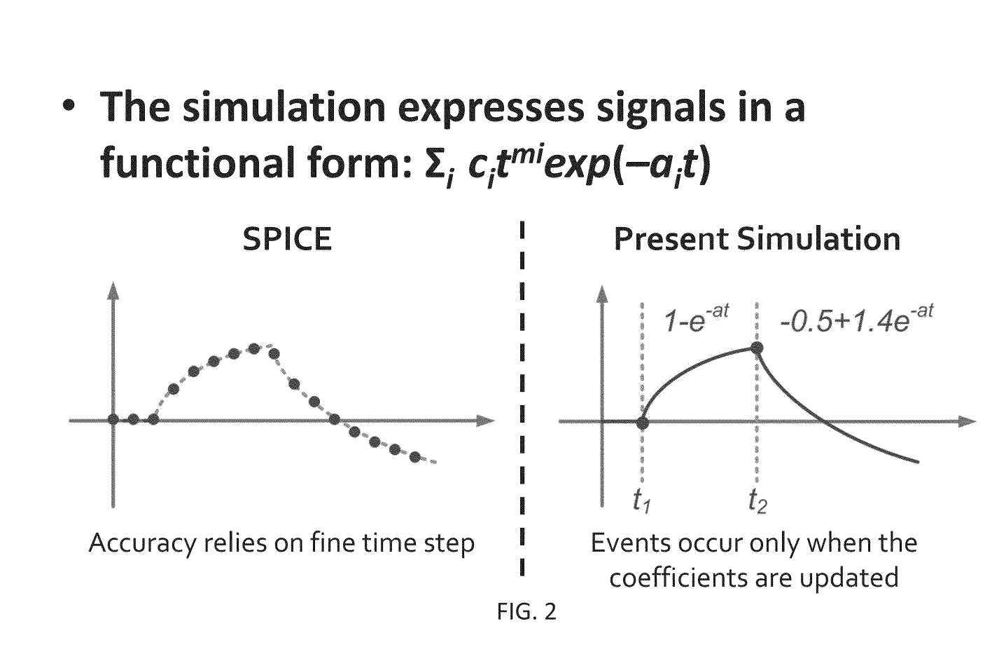

FIG. 2 illustrates the conception of the simulation of the present disclosure.

As addressed above, the input signal x(t) expressed with the linear combination of the basis functions ct^{m}e^{a t}, i.e. x(t)=Σᵢcᵢt^{m}^{ᵢ}e^{-a}^{ᵢ}^{t}, can accurately express all possible input signals including sinusoids, exponentials, ramps, steps, etc. When the input signal x(t) is expressed with the linear combination of the basis functions, the output response y(t) of the weakly nonlinear system can be obtained by solving the ordinary differential equations (ODEs) of x(t) as described below. Thus, when coefficients of the input signal x(t) change, i.e. the cᵢ, mᵢ, and aᵢ of the input signal x(t) change (an input event occurs), the coefficients of the output response y(t) have only to be updated, which can accurately replicate the output response of the weakly nonlinear system. The basis functions can be easily converted to Laplace s-domain, so the coefficients of the output response y(t), and input signal x(t), i.e. the cᵢ, mᵢ, and aᵢ can be easily obtained via algebraic computations only. Since the output response y(t) can be obtained only when new events occur, as opposed to the SPICE simulation, the accuracy and speed of the simulation of the present disclosure in an event driven way are enhanced significantly.

Hereinafter, specific details of the simulation of the present disclosure will be explained with an example.

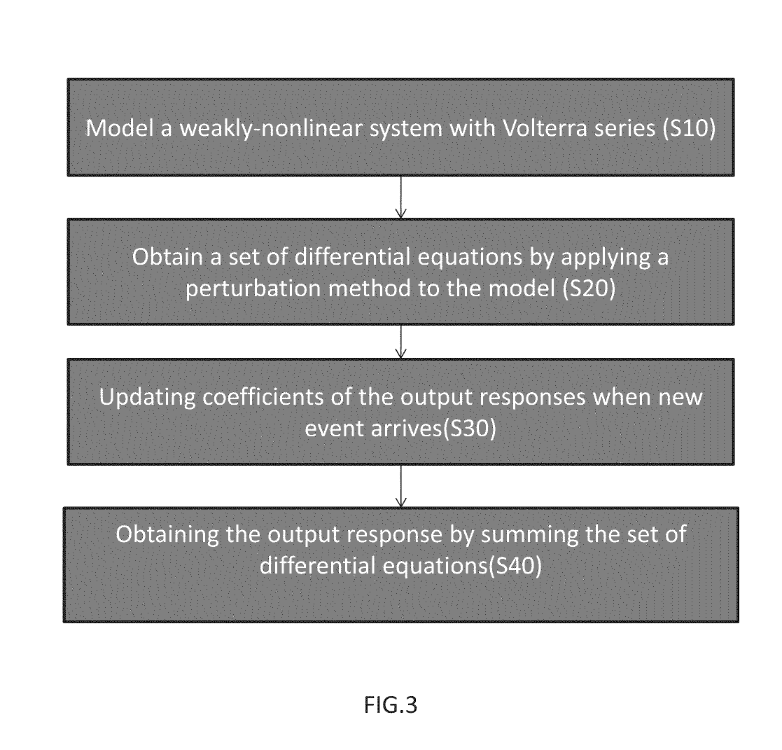

FIG. 3 is a flow chart illustrating a method for simulating a behavior of a weakly nonlinear dynamical system in an event-driven way according to an embodiment.

A weakly nonlinear dynamical system, which shows only minor deviations from the linear response, is modeled as the below equation (1).

$$\frac{\partial }{\partial t} [ {C}_{1} y ( t ) + {C}_{2} {y}^{2} ( t ) + {C}_{3} {y}^{3} ( t ) + … ] + {G}_{1} y ( t ) + {G}_{2} {y}^{2} ( t ) + {G}_{3} {y}^{3} ( t ) + … = b \cdot x ( t ) \qquad ( 1 )$$

where,
y(t) is the output response
x(t) is the input signal
Cᵢ, Gᵢ, and b are system coefficients.

To this end, the output response of the nonlinear system y(t) may be modeled witha Volterra series in a form of sum of responses at different orders as below. (S10) While the Volterra series is similar to and develops from the Taylor series, the Volterra series is a more appropriate model for describing a nonlinear dynamical system with memory.

y(t)=y₁(t)+y₂(t)+y₃(t)+ . . . +yₙ(t) (2)

yₖ is the k-th order response related to a Volterra kernel of the order k, hₖ(τ₁, . . . , τₖ):

yₖ(t)=∫₀^{t} . . . ∫₀^{t}hₖ(τ₁, . . . ,τₖ)x(t−τ₁) . . . x(t−τₖ)dτ₁ . . . dτₖ (3)

The Volterra series type equations, however, are difficult to perform s-domain algebraic computations. So, the above equations need to be reformulated to equations which are subject to s-domain computations. Thus, the first goal of the present simulating is to reformulate the equation (1) into a set of multiple ODEs with various distortion orders, each of which includes the k-th order output response yₖ(t) and its derivative

$$\frac{d {y}_{k} ( t )}{d t}$$

as below.

$${A}_{k} {y}_{k} ( t ) + \frac{d {y}_{k} ( t )}{d t} = Polynomial of ( x ( t ) , {y}_{1} ( t ) , … , {y}_{k - 1} ( t ) )$$

The output response of the weakly nonlinear system can be described with only the first few order components from the equation (2), since the output response of the weakly nonlinear circuit deviates from the output response of the linear circuit slightly. Next, the equation (1) is decomposed to a set of sub-system equations with a perturbation method. (S20) The perturbation method considers the equation (2) when the small signal input x(t) is scaled by a small amount \tilde{x}(t)=εx(t). The scaling converts the equation (2) into the below equation (4). By reorganizing the equation (1) with the perturbation method, the equation (1) turns to a set of linearized differential equations (7)-(9) as below.

\tilde{y}(t)=εy₁(t)+ε²y₂(t)+ . . . +εⁿyₙ(t) (4)

By substituting \tilde{y}(t) of equation (4) into y(t) and x(t) to εx(t), the equation (1) is changed to the below equation (5).

$$\frac{\partial }{\partial t} [ \begin{matrix}{C}_{1} ( ɛ {y}_{1} + {ɛ}^{2} {y}_{2} + … + {ɛ}^{n} {y}_{n} ) + \\ \begin{matrix}{{C}_{2} ( ɛ {y}_{1} + {ɛ}^{2} {y}_{2} + … + {ɛ}^{n} {y}_{n} )}^{2} + \\ {{C}_{3} ( ɛ {y}_{1} + {ɛ}^{2} {y}_{2} + … + {ɛ}^{n} {y}_{n} )}^{3} + …\end{matrix}\end{matrix} ] + {G}_{1} ( ɛ {y}_{1} + {ɛ}^{2} {y}_{2} + … + {ɛ}^{n} {y}_{n} ) + {{G}_{2} ( ɛ {y}_{1} + {ɛ}^{2} {y}_{2} + … + {ɛ}^{n} {y}_{n} )}^{2} + {{G}_{3} ( ɛ {y}_{1} + {ɛ}^{2} {y}_{2} + … + {ɛ}^{n} {y}_{n} )}^{3} + … = b \cdot ɛ x \qquad ( 5 )$$

By rearranging the equation (5), the equation becomes the below equation (6).

$$ɛ [ \frac{\partial }{\partial t} ( {C}_{1} {y}_{1} ) + {G}_{1} {y}_{1} - bx ] + {ɛ}^{2} [ \frac{\partial }{\partial t} ( {C}_{1} {y}_{2} + {C}_{2} {y}_{1}^{2} ) + {G}_{1} {y}_{2} + {G}_{2} {y}_{1}^{2} ] + {ɛ}^{3} [ \begin{matrix}\frac{\partial }{\partial t} ( {C}_{1} {y}_{3} + 2 {C}_{2} {y}_{1} {y}_{2} + {C}_{3} {y}_{1}^{3} ) + \\ {G}_{1} {y}_{3} + 2 {G}_{2} {y}_{1} {y}_{2} + {G}_{3} {y}_{1}^{3}\end{matrix} ] + {ɛ}^{4} [ … ] + … = 0 \qquad ( 6 )$$

Since the equation (6) should be satisfied for an arbitrary ε, the expressions inside parenthesis should be zero. The first three terms results in the following equations (7)-(9).

$$\begin{matrix}\frac{\partial }{\partial t} ( {C}_{1} {y}_{1} ) + {G}_{1} {y}_{1} = bx & ( 7 ) \\ \frac{\partial }{\partial t} ( {C}_{1} {y}_{2} ) + {G}_{1} {y}_{2} = - \frac{\partial }{\partial t} ( {C}_{2} {y}_{1}^{2} ) - {G}_{2} {y}_{1}^{2} & ( 8 ) \\ \frac{\partial }{\partial t} ( {C}_{1} {y}_{3} ) + {G}_{1} {y}_{3} = - \frac{\partial }{\partial t} ( 2 {C}_{2} {y}_{1} {y}_{2} + {C}_{3} {y}_{1}^{3} ) - 2 {G}_{2} {y}_{1} {y}_{2} - {G}_{3} {y}_{1}^{3} & ( 9 )\end{matrix}$$

The left hand side of the equations (7)-(9) is a linear function of the k-th order output response yₖ(t) and its derivative

$$\frac{d {y}_{k} ( t )}{d t} .$$

The right hand side of the equations (7)-(9) is a polynomial of the input signal bx(t) and the lower-than-k order responses y₁(t), . . . , yₖ₋₁(t). Since the left hand side of the equations consists of k-th order output response and the right hand side of the equations is expressed with the polynomial of the lower order responses y₁(t), . . . , yₖ₋₁(t), each order of output responses can be obtained in a recursive way. For instance, after obtaining the first order output response y₁(t), the second order output response y₂(t) can be obtained, and the third output response y₃(t) can be obtained from the first order and 2^{nd} order output responses y₁(t), y₂(t).

To obtain each order of the output responses, coefficients of the set of differential equations (7)-(9) need to be calculated. As addressed above, the present simulation method updates the coefficients of each order of the output responses when the parameters of the input signal (x(t)) changes (new event occurs). (S30)

As addressed above, the input signal x(t), and the output responses y₁(t), . . . , yₙ(t) are expressed with the linear combination of the basis functions ct^{m}e^{a t}, and the differential equations (7)-(9) can be conveniently solved using only algebraic computations in the s-domain. The coefficients of the differential equations (7)-(9) are calculated in the s-domain, when the new event occurs. The Laplace transform for the time derivative is defined as below equation (10).

$$ℒ \{ \frac{\partial f ( t )}{\partial t} \} = s ℒ \{ f ( t ) \} - f ( 0 ) \qquad ( 10 )$$

The equations (7)-(9) are transferred to s-domain via Laplace transform respectively as below equations (11)-(13).

$$\begin{matrix} {Y}_{1} ( s ) = \frac{b}{{sC}_{1} + {G}_{1}} \cdot X ( s ) + \frac{{C}_{1}}{{sC}_{1} + {G}_{1}} \cdot {y}_{1} ( 0 ) & ( 11 ) \\ {Y}_{2} ( s ) = - \frac{{sC}_{2} + {G}_{2}}{{sC}_{1} + {G}_{1}} \cdot ℒ \{ {y}_{1}^{2} ( t ) \} + \frac{{C}_{2}}{{sC}_{1} + {G}_{1}} \cdot {y}_{1}^{2} ( 0 ) + \frac{{C}_{1}}{{sC}_{1}} {y}_{2} ( 0 ) & ( 12 ) \\ {Y}_{3} ( s ) = - \frac{{sC}_{3} + {G}_{3}}{{sC}_{1} + {G}_{1}} \cdot ℒ \{ {y}_{1}^{3} ( t ) \} + \frac{{C}_{3}}{{sC}_{1} + {G}_{1}} \cdot {y}_{1}^{3} ( 0 ) - \frac{s 2 {C}_{2} + 2 {G}_{2}}{{sC}_{1} + {G}_{1}} \cdot L \{ {y}_{1} ( t ) {y}_{2} ( t ) \} + \frac{2 {C}_{2}}{{sC}_{1} + {G}_{1}} \cdot {y}_{1} ( 0 ) {y}_{2} ( 0 ) + \frac{{C}_{1}}{{sC}_{1} + {G}_{1}} {y}_{3} ( 0 ) & ( 13 )\end{matrix}$$

where, X(s)= [symbol] {x(t)} and Yₖ(S)= [symbol] {yₖ(t)}

If only up to third order responses are included, the sum of the equations (11)-(13) are the output of the system. The equations (11)-(13) still have time domain multiplication. To address the time domain multiplication, we introduce an s-domain operator A₂ to perform a time-domain multiplication between two signals, z₁(t)=Σᵢcᵢt^{m}^{ᵢ}e^{-a}^{ᵢ}^{t} and z₂(t)=Σⱼc′ⱼt^{m′}^{ⱼ}e^{-a′}^{ⱼ}^{t}.

The s-domain operator is defined as the below equation (14).

$${A}_{2} [ {Z}_{1} ( s ) , {Z}_{2} ( s ) ] = {\sum }_{i , j} ( {m}_{i} + {m}_{j}^{′} - 2 ) ! \frac{{c}_{i} {c}_{j}^{′}}{{( s + {a}_{i} + {a}_{j}^{′} )}^{{m}_{i} + {m}_{j}^{′} - 1 }} \qquad ( 14 )$$

where, Z₁ (s)= [symbol] {z₁(t)} and Z₂ (s)= [symbol] {z₂(t)}

Using the operator A₂, the equations (11)-(13) governing the different-order responses of the output signal y₁(t), y₂(t), and y₃(t), become the following equations (15)-(17) in s-domain, where Y₁(s), Y₂(s), and Y₃(s) are the Laplace transforms of y₁(t), y₂(t), and y₃(t), respectively,

$$\begin{matrix} {Y}_{1} ( s ) = \frac{b}{{sC}_{1} + {G}_{1}} \cdot X ( s ) + \frac{{C}_{1}}{{sC}_{1} + {G}_{1}} \cdot {y}_{1} ( 0 ) & ( 15 ) \\ {Y}_{2} ( s ) = - \frac{{sC}_{2} + {G}_{2}}{{sC}_{1} + {G}_{1}} \cdot {A}_{2} [ {Y}_{1} ( s ) , {Y}_{1} ( s ) ] + \frac{{C}_{2}}{{sC}_{1} + {G}_{1}} \cdot {y}_{1}^{2} ( 0 ) + \frac{{C}_{1}}{{sC}_{1} + {G}_{1}} {y}_{2} ( 0 ) & ( 16 ) \\ {Y}_{3} ( s ) = - \frac{{sC}_{3} + {G}_{3}}{{sC}_{1} + {G}_{1}} \cdot {A}_{2} [ {A}_{2} [ {Y}_{1} ( s ) , {Y}_{1} ( s ) ] , {Y}_{1} ( s ) ] + \frac{{C}_{3}}{{sC}_{1} + {G}_{1}} \cdot {y}_{1}^{3} ( 0 ) - \frac{s 2 {C}_{2} + 2 {G}_{2}}{{sC}_{1} + {G}_{1}} \cdot {A}_{2} [ {Y}_{1} ( s ) , {Y}_{2} ( s ) ] + \frac{2 {C}_{2}}{{sC}_{1} + {G}_{1}} \cdot {y}_{1} ( 0 ) {y}_{2} ( 0 ) + \frac{{C}_{1}}{{sC}_{1} + {G}_{1}} {y}_{3} ( 0 ) & ( 17 )\end{matrix}$$

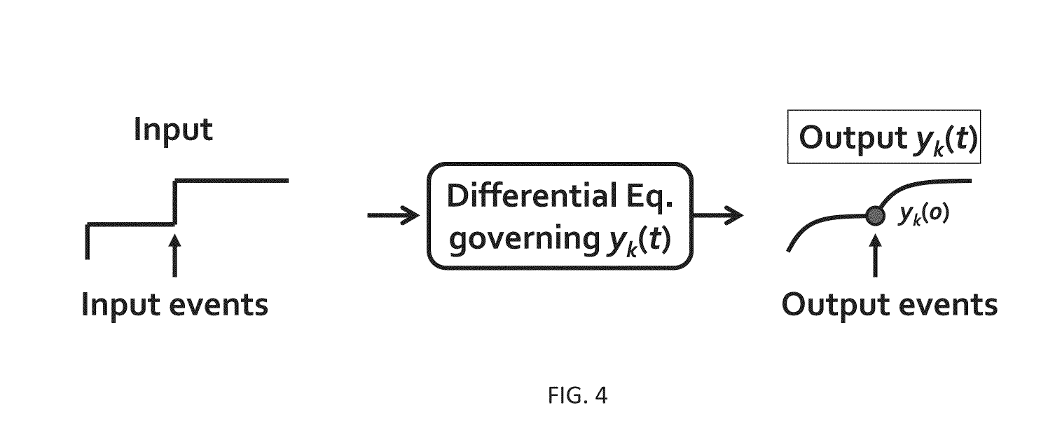

FIG. 4 illustrates the initial condition concept of the present simulation. The Laplace transform requires initial conditions of each of the output responses y₁ (0), y₂(0), y₃(0). The initial conditions of each of the output responses, y₁(0), y₂(0), y₃(0) denotes values of the output responses y₁(t), y₂(t), y₃(t) right before the new input event arrives, which captures the remaining effects of the previous input events. By setting the values of the output responses right before the new input event arrives as the initial conditions of the output responses, the coefficients of the above equations (15)-(17) can be calculated. By obtaining the coefficients of the equations (15)-(17) at the time (here t=0) a new event is inputted, each order of the output responses in the s-domain (15)-(17) is defined in a recursive way. That is, Y₁(s) is obtained first, and then Y₂(s) and Y₃(s) are defined in that order.

The s-domain equations (15)-(17) are transformed to time domain equations, after the s-domain equations (15)-(17) are defined. The transformed time domain equations are summed to result in the final output signal y(t). (S40)

Above example is based on a one-dimensional case. However, it is not limited to the one-dimensional system and can be applied to a multi-dimensional case.

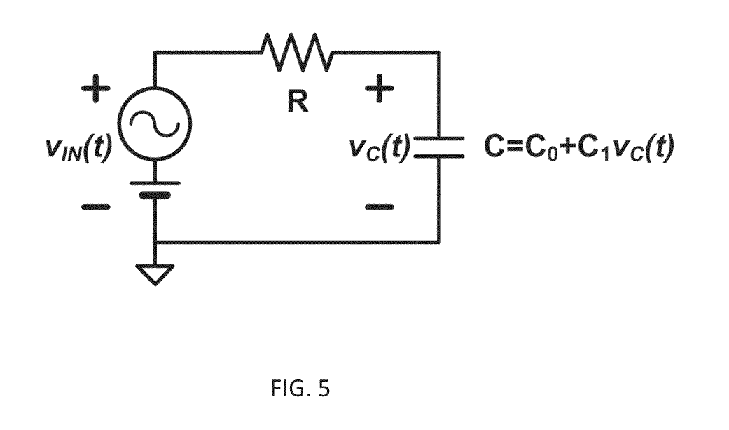

The obtained output signal y(t) is effective and well replicates the output behavior of the weakly nonlinear dynamical system until a next new event is inputted to the nonlinear dynamical system, that is until the coefficients of the input signal x(t) change. This will enhance accuracy in replicating the behaviors of the weakly nonlinear dynamical system, and achieves a faster simulation, for instance of an electronic circuit, 300˜1000× faster compared to the SPICE simulation. FIG. 5 illustrates comparison of the accuracy and speed of the SPICE simulation and the present simulation.

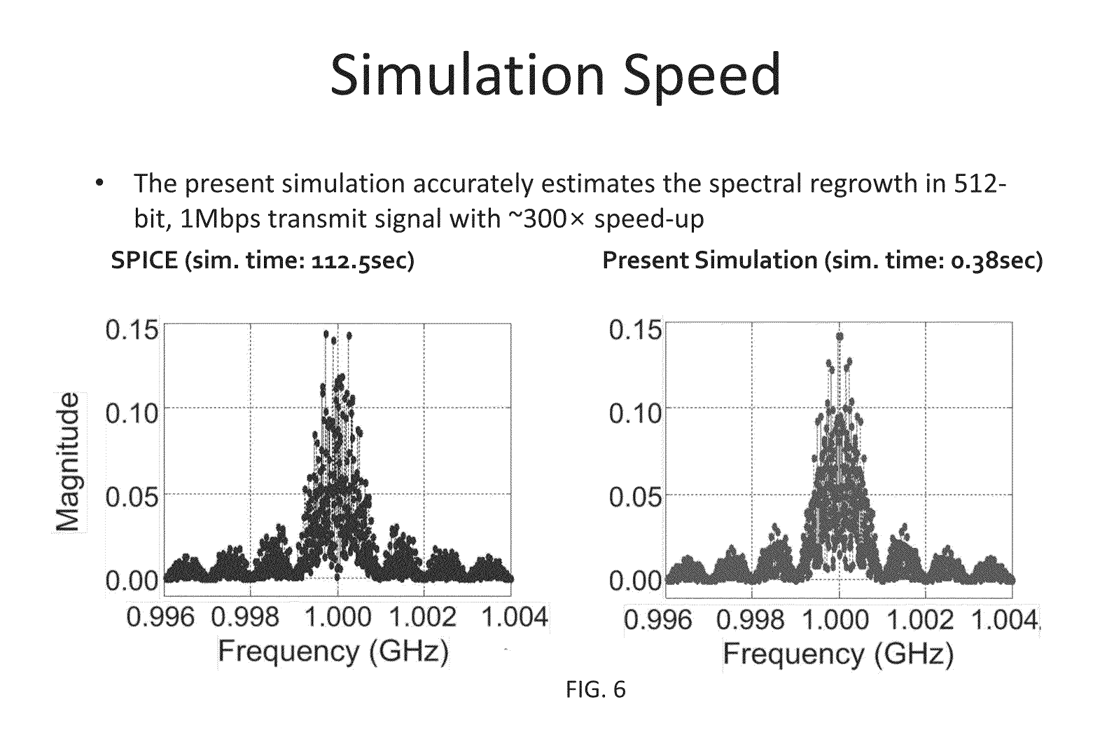

An example of simulating a weakly nonlinear circuit in an event-driven way will be explained hereinafter with reference to FIG. 6. FIG. 6 illustrates an R-C circuit of which outputs show weakly nonlinear behaviors. The equation of the nonlinear R-C circuit is constructed as the below equation (18).

$$\frac{\partial }{\partial t} ( {Rc}_{0} {v}_{C} ( t ) + \frac{{Rc}_{1}}{2} {v}_{C}^{2} ( t ) ) + {v}_{C} ( t ) = {v}_{IN} ( t ) \qquad ( 18 )$$

where ν_{IN}(t) is an input signal, and ν_{C}(t) is an output signal to simulate.

Comparing the equation (18) to the target model equation (1), the coefficients of the target model can be computed in terms of circuit parameters, c₀, c₁ and R, as follows.

$${C}_{1} = {Rc}_{0} , {C}_{2} = \frac{{Rc}_{1}}{2} , {C}_{3} = {C}_{4} = … = 0 , \\ {G}_{1} = 1 , {G}_{2} = {G}_{3} = {G}_{4} = … = 0 , \\ b = 1.$$

The output signal ν_{C}(t) is modeled as a sum of k-th-order responses, ν_{Ck}(t), by use of the Volterra series model. In this example, the first to third order responses are used.

ν_{C}(t)=ν_{C1}(t)+ν_{C2}(t)+ν_{C3}(t) (19)

If the perturbation method is applied to the above equation (19), the following set of differential equations can be obtained.

$$\begin{matrix}\frac{\partial }{\partial t} ( {Rc}_{0} {v}_{C 1} ( t ) ) + {v}_{C 1} ( t ) = {v}_{IN} ( t ) & ( 20 ) \\ \frac{\partial }{\partial t} ( {Rc}_{0} {v}_{C 2} ( t ) ) + {v}_{C 2} ( t ) = - \frac{\partial }{\partial t} ( \frac{{Rc}_{1}}{2} {v}_{C 1}^{2} ( t ) ) & ( 21 ) \\ \frac{\partial }{\partial t} ( {Rc}_{0} {v}_{C 3} ( t ) ) + {v}_{C 3} ( t ) = - \frac{\partial }{\partial t} ( {Rc}_{1} {v}_{C 1} ( t ) {v}_{C 2} ( t ) ) & ( 22 )\end{matrix}$$

The equations (20)-(22) are converted to s-domain equations as the following equations (23)-(25).

$$\begin{matrix} {V}_{C 1} ( s ) = \frac{1}{{sRc}_{0} + 1} \cdot {V}_{IN} ( s ) + \frac{{Rc}_{0}}{{sRc}_{0} + 1} \cdot {v}_{C 1} ( 0 ) & ( 23 ) \\ {V}_{C 2} ( s ) = - \frac{{sRc}_{1} / 2}{{sRc}_{0} + 1} \cdot ℒ \{ {v}_{C 1}^{2} ( t ) \} + \frac{{Rc}_{1} / 2}{{sRc}_{0} + 1} \cdot {v}_{C 1}^{2} ( 0 ) + \frac{{Rc}_{0}}{{sRc}_{0} + 1} {v}_{C 2} ( 0 ) & ( 24 ) \\ {V}_{C 3} ( s ) = - \frac{{sRc}_{1}}{{sRc}_{0} + 1} \cdot ℒ \{ {v}_{C 1} ( t ) {v}_{C 2} ( t ) \} + \frac{{sRc}_{1}}{{sRc}_{0} + 1} \cdot {v}_{C 1} ( 0 ) {v}_{C 2} ( 0 ) + \frac{{Rc}_{0}}{{sRc}_{0} + 1} {v}_{C 3} ( 0 ) & ( 25 )\end{matrix}$$

To deal with the time-domain multiplication, the s-domain operator A2 is applied to the equations (23)-(25), which results in the following equations (26)-(28).

$$\begin{matrix} {V}_{C 1} ( s ) = \frac{1}{{sRc}_{0} + 1} \cdot {V}_{IN} ( s ) + \frac{{Rc}_{0}}{{sRc}_{0} + 1} \cdot {v}_{C 1} ( 0 ) & ( 26 ) \\ {V}_{C 2} ( s ) = - \frac{{sRc}_{1} / 2}{{sRc}_{0} + 1} \cdot {A}_{2} [ {V}_{C 1} ( s ) , {V}_{C 1} ( s ) ] + \frac{{Rc}_{1} / 2}{{sRc}_{0} + 1} \cdot {v}_{C 1}^{2} ( 0 ) + \frac{{Rc}_{0}}{{sRc}_{0} + 1} {v}_{C 2} ( 0 ) & ( 27 ) \\ {V}_{C 3} ( s ) = - \frac{{sRc}_{1}}{{sRc}_{0} + 1} \cdot {A}_{2} [ {V}_{C 1} ( s ) , {V}_{C 2} ( s ) ] + \frac{{sRc}_{1}}{{sRc}_{0} + 1} \cdot {v}_{C 1} ( 0 ) {v}_{C 2} ( 0 ) + \frac{{Rc}_{0}}{{sRc}_{0} + 1} {v}_{C 3} ( 0 ) & ( 28 )\end{matrix}$$

After knowing the coefficients of the equations (26)-(28), an inverse Laplace transform of the equations (26)-(28) and combination of the results of the inverse Laplace transform obtains the simulated responses of the output signal ν_{C}(t) in an event driven way.

The above simulation method is implemented with a computer or the like in which a program or computer executable instructions to perform the above simulation method are embedded.

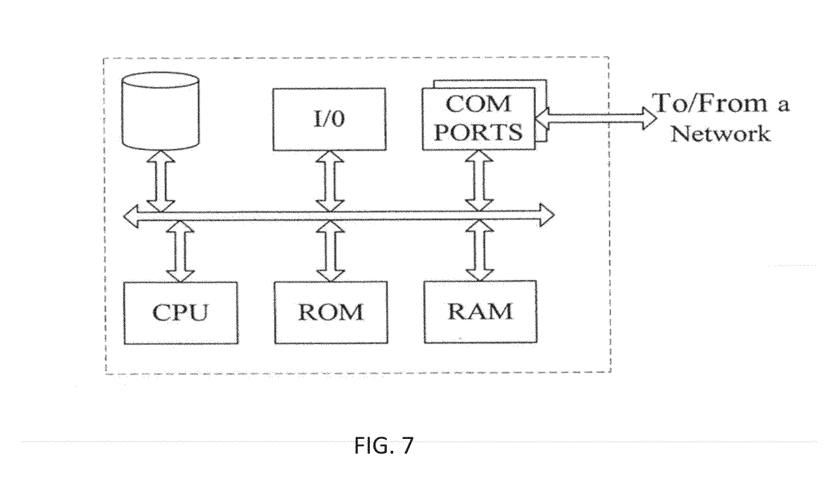

FIG. 7 depicts a computer with user interface elements, which may be used to implement a personal computer or other type of work station or terminal device, although the computer of FIG. 7 may also act as a server if appropriately programmed. It is believed that the general structure and general operation of such equipment as shown in FIG. 7 should be self-explanatory from the high-level illustrations.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs. A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature.

Hence, aspects of the methods of simulating a weakly nonlinear circuit outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the simulation method, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of simulating an output of a nonlinear system, comprising:
modeling the output of the nonlinear system with a set of differential equations, the set of differential equations being expressed with a combination of first order to n-th order output responses and an input signal with coefficients thereof;
updating the coefficients of the first order to n-th order output responses at the time the coefficients of the input signal change to thereby obtain the first order to n-th order output responses; and
obtaining the output of the nonlinear system by summing the first order to n-th order output responses,
wherein n is an integer greater than or equal to 2.

2. The method of claim 1, wherein the step of modeling the output of the nonlinear system includes:
modeling the output of the nonlinear system with a Volterra series; and
reformulating the modeled output to the set of differential equations.

3. The method of claim 2, wherein each of the set of differential equations governing the k-th order output response yₖ(t) has one side expressed with n-tha linear combination of the k-th order output response yₖ(t) and time derivative of the k-th order output response yₖ(t), and the other side expressed with a polynomial of the input signal x(t) and the lower-than-k order first output responses y₁(t), . . . , yₖ₋₁(t), wherein that k is an integer between 2 and n.

4. The method of claim 3, wherein the set of differential equations are obtained with a perturbation method.

5. The method of claim 1, wherein the step of updating the coefficients includes:
setting the first order to n-th order output responses at the time the new input signal is inputted as initial conditions of the first order to n-th order output responses;
transforming each of the set of differential equations into s-domain equations with the set initial conditions;
computing the first order to n-th-order output responses in s-domain;
obtaining the coefficients of the first order to n-th order output responses.

6. The method of claim 1, wherein the input signal, and the first to n-th order output responses are expressed as a sum of one or more exponential basis functions ct^{m}e^{a t}, wherein m is an integer and a is a complex number.

7. The method of claim 1, wherein the obtained output of the nonlinear system is effective from the time of a change of the coefficients of the input signal to the time of the next change of the coefficients of the input signal.

8. A non-transitory computer readable medium including instructions stored therein, which when executed by a processor, cause the processor to perform operations comprising:
modeling the output of the nonlinear system with a set of differential equations, the set of differential equations being expressed with a combination of first order to n-th order output responses and an input signal with coefficients thereof;
updating the coefficients of the first order to n-th order output responses when the coefficients of the input signal change to obtain the first order to n-th order output responses; and
obtaining the output of the nonlinear system by summing the first order to n-th order output responses,
wherein n is an integer greater than or equal to 2.

9. The medium of claim 8, wherein the step of modeling the output of the nonlinear system includes:
modeling the output of the nonlinear system with a Volterra series; and
reformulating the modeled output to the set of differential equations.

10. The medium of claim 9, wherein each of the set of differential equations governing the k-th order output response yₖ(t) has one side expressed with a linear combination of the k-th order output response yₖ(t) and time derivative of the k-th order output response yₖ(t), and the other side expressed with a polynomial of the input signal x(t) and the lower-than-k firstoutput responses y₁(t), . . . , yₖ₋₁(t), wherein that k is an integer between 2 and n.

11. The medium of claim 9, wherein the set of differential equations are obtained with a perturbation method.

12. The medium of claim 8, wherein the step of updating the coefficients includes:
setting the first order to n-th order output responses at the time the new input signal is inputted as initial conditions of the first order to n-th order output responses;
transforming each of the set of differential equations into s-domain equations with the set initial conditions;
computing the first-order to n-th order output responses in s-domain;
obtaining the coefficients of the first order to n-th order output responses.

13. The medium of claim 8, wherein the input signal, and the first to n-th order output responses are expressed as a sum of one or more exponential basis functions ct^{m}e^{a t}.

14. The medium of claim 8, wherein the obtained output of the nonlinear system is effective from the time of a change of the coefficients of the input signal to the time of the next change of the coefficients of the input signal.
